(19) United States
(12) Patent Application Publication
(10) Pub. No.: US 2008/0139153 A1
(43) Pub. Date: Jun. 12, 2008

(54) ANTENNA CONFIGURATION SELECTION USING OUTDATED CHANNEL STATE INFORMATION

(75) Inventors: Luo Tuo, Shenzhen (CN); Tsang Yui Ming, Sheung Shui (HK); Roger Shu Kwan Cheng, Tseung Kwan O (HK); Vincent Kin Nang Lau, Tseung Kwan O (HK)

Correspondence Address: FULBRIGHT & JAWORSKI L.L.P, 2200 ROSS AVENUE, SUITE 2800, DALLAS, TX, 75201-2784, US

(73) Assignee: Hong Kong Applied Science and Technology Research Institute Co., Ltd., Shatin (CN)

(21) Appl. No.: 11/609,545

(22) Filed: Dec. 12, 2006

(51) Int. Cl. H04B 7/02

(52) U.S. Cl. 455/277.2

(57) ABSTRACT

Systems and methods for antenna configuration selection using weighted outdated channel state information are shown. Outdated channel state information may be used in combination with statistical channel information for estimating channel state information according to embodiments of the invention. For example, by combining channel state information, weighted by its temporal relevance, with statistical information, recent channel performance may be used along with historical performance information for antenna configuration selection. Antenna selection of embodiments may be provided for multiple input multiple output (MIMO) systems, such as wireless systems employing multiple radio frequency chains and multiple antennas.

### RELATED APPLICATIONS

The present application is related to co-pending, commonly assigned U.S. patent application Ser. No. [64032-P028US-10609149] entitled “Pre-Processing Systems and Methods for MIMO Antenna Systems,” filed concurrently herewith, the disclosure of which is hereby incorporated herein by reference.

### TECHNICAL FIELD

The invention relates generally to communication systems and more particularly to antenna configuration selection for communication.

### BACKGROUND OF THE INVENTION

Communication systems are often limited in bandwidth and throughput by the communication channel utilized in providing the communication. By communication channel, the media environment of the route that the communication signals experience when traveling from stations communicating with each other is meant, as opposed to a defined channel used in communications, such as a frequency division channel, a time division channel, or a code division channel. As one of ordinary skill in the art will appreciate, various defined channels may be utilized with respect to a communication channel to facilitate desired communications, such as to provide multiple access, duplexing, etcetera. In wireless communication systems, for example, the communication channel may comprise free space as affected by interference, fading, multipath, scattering, shadowing, etcetera.

It should be appreciated that the state of the communication channel, and thus its effect on communications therethrough, may change in time. Accordingly, various techniques for compensating for changes in the communication channel state have been developed.

One technique for compensating for changes in the communication channel state with respect to wireless communications is to implement multiple input, multiple output (MIMO) antenna technology. A MIMO system, as shown in FIG. 1A, uses multiple antennas at both the source (shown as transmitter 110A) and the destination (shown as receiver 120A). A signal is transmitted at multiple antennas (e.g., antennas 111-114) by the transmitter and received at multiple antennas (e.g., antennas 121-124) by the receiver after propagating through the communication channel (shown as communication channel 101). The received signal is combined to minimize errors, multipath and scattering effects, fading, etcetera and to optimize data speed and throughput. Although often effective at compensating for various changes in channel states, the use of MIMO systems is not without disadvantage. In particular, the number of radio frequency (RF) chains (e.g., RF transmitter chains 151-154 and RF receiver chains 161-164) associated with a MIMO system can be expensive to deploy, operate, and maintain.

Another technique for compensating for changes in the communication channel state with respect to wireless communications is to implement antenna selection technology. A switched antenna system, as shown in FIG. 1B, uses multiple antennas at the source (shown as transmitter 110B) and/or the destination (shown as receiver 120B) to provide transmit and/or receive diversity (e.g., spatial diversity) using a single RF chain at each end of the communication link (shown as RF chain 151 at the transmitter and RF chain 161 at the receiver). For example, a signal is transmitted at a selected antenna (e.g., a selected one of antennas 111-114), as may be selected by antenna selection circuitry (shown as antenna selector 150) by the transmitter and received at a selected antenna (e.g., a selected one of antennas 121-124), as may be selected by antenna selection circuitry (shown as antenna selector 160) by the receiver after propagating through the communication channel. The particular antennas used are typically selected based upon a measurement of channel state information (CSI). Alternatively, the particular antennas used may be selected based upon statistical channel knowledge (SCK) using purely spatial channel correlations. Although often effective at compensating for various changes in channel states, antenna selection based on measurement only or statistical channel knowledge only still have room for improvement. In particular, although presumed to be a perfect representation of channel state, channel state information is measured at some time other than the time of transmission and thus is outdated. Moreover, channel state information must either be measured at the receiver, requiring time and bandwidth for information feedback to the transmitter for channel selection, or measured by measuring transmitter feedback signal strength, leading to the measurements being outdated. However, the results provided using channel state information are directly related to the accuracy of the channel state measurements used. Statistical channel knowledge relies upon time averaging to provide acceptable results, and thus often provides very poor instantaneous results.

### BRIEF SUMMARY OF THE INVENTION

The present invention is directed to systems and methods which implement one or more uncertainty factors with respect to channel state information for selecting a communication configuration to implement for a desired communication. For example, according to a preferred embodiment, an uncertainty factor or factors is used with respect to outdated channel state information for selecting one or more antennas in a wireless communication system. According to a preferred embodiment, a current channel state is estimated using a correlation factor (a first uncertainty factor) with out of date channel state information. This current channel state estimate may further include use of a randomness factor (a second uncertainty factor). The current channel state estimate derived according to embodiments of the invention may be utilized in selecting antenna configurations for use in providing desired performance characteristics, such as best bit error rate, best data rate, highest signal quality, highest signal to noise ratio, least interference, etcetera.

Embodiments of the invention provide a current channel state estimate using outdated channel state information, weighted by its temporal relevance (e.g., a temporal correlation factor), and statistical information (e.g., a randomness factor derived from statistical spatial correlation of the channel), which may also be weighted (e.g., inversely weighted) by the temporal relevance of the outdated channel state information. Accordingly, embodiments may utilize recent channel performance along with historical performance information in estimating a current channel state. The use of the foregoing weighted outdated channel state information and statistical information according to preferred embodiments facilitates current channel estimation which is bounded by perfect channel state information, where the temporal relevance of the outdated channel state information is high (e.g., “1”), and by pure statistical channel knowledge, where the temporal relevance of the outdated channel state information is low (e.g., “0”). Moreover, current channel state estimates can be tailored for different degrees of outdatedness of the outdated channel state information between the foregoing boundary conditions. Current channel state estimates provided according to embodiments of the invention may thus provide the benefits of the technique providing the closest correlation to the current channel state at the corresponding boundary condition, while providing benefits of both techniques between the boundary conditions.

Embodiments of the invention provide for antenna selection by obtaining channel state information and statistical channel information, determining a channel model using a weighted combination of the channel state information and the statistical channel information, and using the channel model to select one or more antenna configurations from a plurality of antenna configurations for use in communications. The channel model preferably includes the effect of a time delay between the time of obtaining channel state information and when a channel is selected. Accordingly, the channel model of embodiments of the invention is determined using an estimate of temporal correlations of signals previously received through the communication channel. The statistical channel information used in determining a channel model according to embodiments of the invention may be derived using techniques well known in the art (such as minimum mean square error (MMSE) estimate based on the received pilot symbols in different packets which in effect, take long term average of channel realizations measurements and employing certain statistical channel model, e.g. the Kronecker model) although a temporal weighting factor is applied with respect thereto according to embodiments of the invention. Accordingly, with increasing delay from the time at which channel state information is obtained, the weight of the channel state information decreases while the weight of the statistical channel information increases in the selection of an antenna configuration according to embodiments of the invention.

In operation according to embodiments of the invention, a receiver makes channel state measurements and determines a channel model therefrom. This channel model is then used by the receiver to determine a desired antenna selection (e.g., a “best” antenna for signal transmission and/or signal reception). The receiver preferably provides antenna selection information to a corresponding transmitter for implementation of the antenna selection.

Embodiments of the invention operate to utilize little communication overhead for implementing antenna selections by providing abbreviated information, such as an index of selected antennas, from the transmitter from the receiver rather than communicating channel state information or other large amounts of information for use in antenna selection.

Embodiments of the invention implement the foregoing antenna selection in combination with MIMO antenna technology. Accordingly, advantages of a MIMO system may be realized, while reducing the number of RF chains implemented through the use of antenna selection.

Although reference has been made herein to selection of antennas, it should be appreciated that such reference is intended to encompass selection between discrete antennas as well as selection between various antenna configurations. For example, antenna selection as discussed herein may be made between different antenna beams (radiation patterns) available from an antenna array. Accordingly, selection may be made, for example, between various operating configurations of a phased array antenna.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1A shows a prior art multiple input, multiple output system;

FIG. 1B shows a prior art antenna selection system;

FIG. 2 shows a communication system adapted according to an embodiment of the present invention;

FIG. 3 shows a flow diagram for antenna selection according to an embodiment of the invention; and

FIG. 4 shows a graph comparing results of antenna selection using techniques of an embodiment of the present invention and prior art techniques.

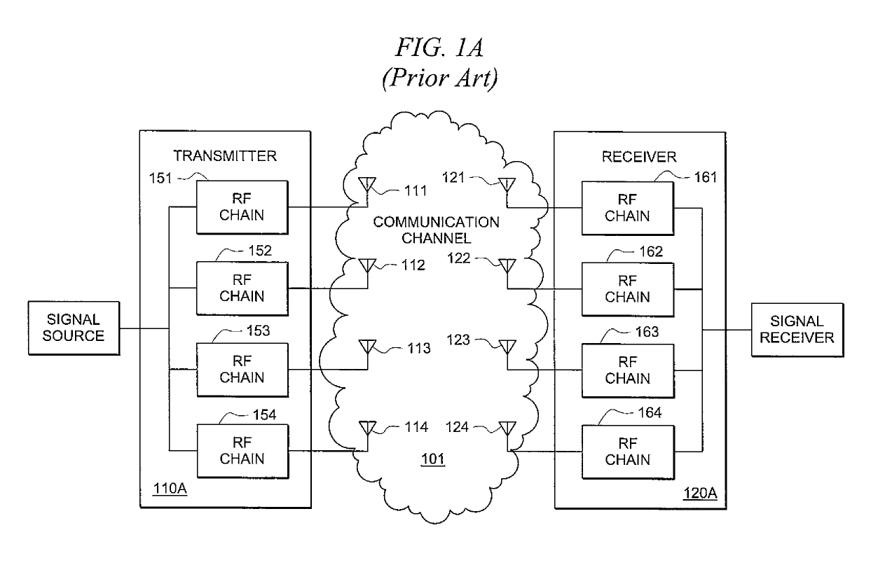

### DETAILED DESCRIPTION OF THE INVENTION

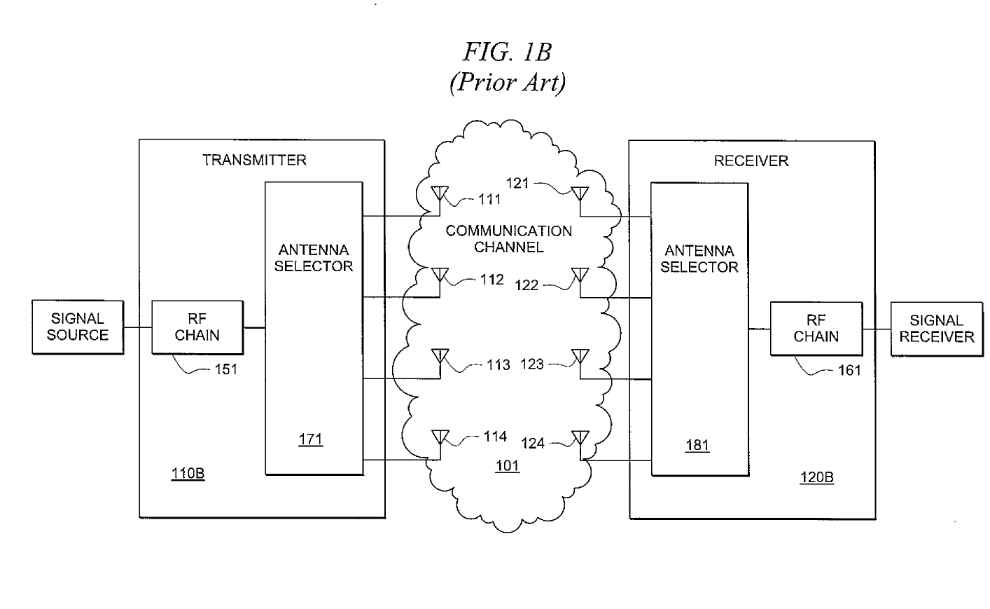

Directing attention to FIG. 2, communication system 200 adapted according to an embodiment of the invention is shown. Communication system 200 of the illustrated embodiment includes transmitter 210 which communicates information from signal source 203 to receiver 220, via wireless communications propagating through communication channel 201, for delivery to signal receiver 204. Although shown as a transmitter and receiver pair in the illustrative embodiment to simplify the discussion for ease of understanding, it should be appreciated that the concepts of the present invention may be utilized with other communication node configurations, such as transceivers, if desired.

Signal source 203 and signal receiver 204 may comprise any of a variety of systems or components for which information communication is desired. For example, signal source 203 and signal receiver 204 may represent nodes in a data network, such as where signal source 203 comprises server equipment (e.g., processor-based or computerized server system as are well known in the art) and signal receiver 204 comprises terminal equipment (e.g., processor-based or computerized user equipment as are well known in the art). Additionally or alternatively, signal source 203 and signal receiver 204 may represent nodes in a communication network, such as where signal source 203 comprises base station equipment (e.g., cellular or personal communication system communication equipment as are well known in the art) and signal receiver 204 comprises mobile equipment (e.g., cellular handset, personal digital assistant, or processor-based or computerized user equipment as are well known in the art).

The illustrated embodiment of communication system 200 utilizes MIMO antenna technology to compensate for changes in the communication channel state, using multiple antennas at both the source (antennas 211-214 at transmitter 210) and the destination (antennas 221-224 at receiver 220). Accordingly, multiple RF chains are provided at transmitter 210 and receiver 220 (RF chains 251 and 252 and RF chains 261 and 262, respectively). In addition to implementing MIMO techniques, the illustrated embodiment of communication system 200 further utilizes antenna selection technology to compensate for changes in the communication channel state. Accordingly, antenna selection circuitry is provided at transmitter 210 and receiver 220 (antenna selector 271 and 272 and antenna selector 281 and 282, respectively) to provide transmit and receive diversity with respect to each RF chain. The illustrated embodiment, implementing both MIMO and antenna selection techniques, provides advantages of MIMO communications with a relatively small number of RF chains. The use of multiple antennas with respect to MIMO RF chains, through the aforementioned antenna selection circuitry, provides advantages of diversity with respect to such RF chains, thereby facilitating optimal use of a relatively small number of RF chains in compensating for communication channel state changes.

It should be appreciated that embodiments of the invention may implement antenna selection with respect to fewer than all RF chains at a transmitter, receiver, or both. Moreover, antenna selection may be implemented only with respect to a transmitter or a receiver according to embodiments of the invention. Furthermore, antenna selection may be implemented according to embodiments of the invention without also implementing MIMO techniques. However, preferred embodiments implement antenna selection at both the transmitter and receiver, in combination with each RF chain of a MIMO system, in order to optimize the ability to compensate for communication channel state changes, and thus optimize bit error rate, data rate, signal quality, signal to noise ratio, effects of interference, and/or the like.

Although the illustrated embodiment shows two RF chains, two antenna selector circuits, and four antennas at each of transmitter 210 and receiver 220, it should be appreciated that various numbers of RF chains, antenna selector circuits, and/or antennas may be utilized according to embodiments of the invention. For example, three or more RF chains may be implemented with respect to transmitter 210 and/or receiver 220. As another example, a single antenna selector circuit may be implemented with respect to multiple RF chains of transmitter 210 and/or receiver 220, such as to provide the ability to select between all antennas for each RF chain. Moreover, although illustrated as separate functional blocks, embodiments of the invention may integrate RF chain circuitry and antenna selector circuitry as a single component, if desired.

It should be appreciated that the antennas represented in FIG. 2 are intended to encompass discrete antennas as well as other antenna configurations. For example, antenna selection as discussed herein may be made between different antenna beams (radiation patterns) available from an antenna array, thus antennas 211-214 and/or antennas 221-224 may represent different antenna beam configurations in such an embodiment.

Preferred embodiments of the present invention implement one or more uncertainty factors with respect to channel state information for antenna selection. For example, a current channel state is preferably estimated using a correlation factor (a first uncertainty factor) with out of date channel state information. This current channel state estimate may further include use of a randomness factor (a second uncertainty factor). Accordingly, embodiments of the invention involve two channel state information sets, one being a perfect description of the channel matrix, but out-of-date, as compared to the time when packet transmissions occur, and the other being an estimate of the current channel state information (at the time when packet transmissions do occur), which is a weighted sum of the outdated channel state information (described above as perfect channel state information) and a random term which incorporates statistical channel knowledge. Statistical channel information measuring long term behavior of the channel, provides a channel correlation factor according to embodiments of the invention. The current channel state estimate is preferably utilized in selecting one or more antennas for providing desired performance characteristics, such as best error rate, best data rate, highest signal quality, highest signal to noise ratio, least interference, etcetera. For example, bursty data systems, such as those operable in accordance with IEEE 802.11 and 802.16 communication standards, typically cannot be operated with up to date channel state information due to the time delays between when a transmission may be monitored to determine channel state information and when data packets are to be transmitted.

Receiver 220, using controller 240 for example, may operate to measure channel state information, estimate a current channel state at a time of data transmission, and select an antenna configuration to implement for the data transmission. According to a preferred embodiment, receiver 220 receives data, such as training packets from transmitter 210, to measure channel state information. The channel state information is used to estimate the channel state at a later time of data transmission, preferably by controller 240 utilizing an algorithm to apply the foregoing uncertainty factors with respect thereto.

The estimated channel state is preferably used to select a antennas for use in the data transmission, such as by controller 240 referencing a decision matrix stored in data store 241. Controller 240 preferably controls antenna selector 281 and/or antenna selector 282 to implement the antenna selection. Moreover, according to a preferred embodiment, transmitter 220 provides antenna selection information to transmitter 210 in the form of a selected antenna index or other abbreviated data set so as to minimize control overhead associated with antenna selection. Embodiments of the invention utilize techniques shown and described in the above referenced patent application entitled “Pre-Processing Systems and Methods for MIMO Antenna Systems” in minimizing control channel overhead with respect to communication of antenna selection information.

Transmitter 210, preferably operating under control of controller 230, receives antenna selection information from receiver 220 and implements the antenna selection. For example, controller 230 may use selected antenna index information to identify particular antennas for use through reference to an antenna configuration matrix of data store 231 and preferably controls antenna selector 271 and/or 272 to implement the antenna selection.

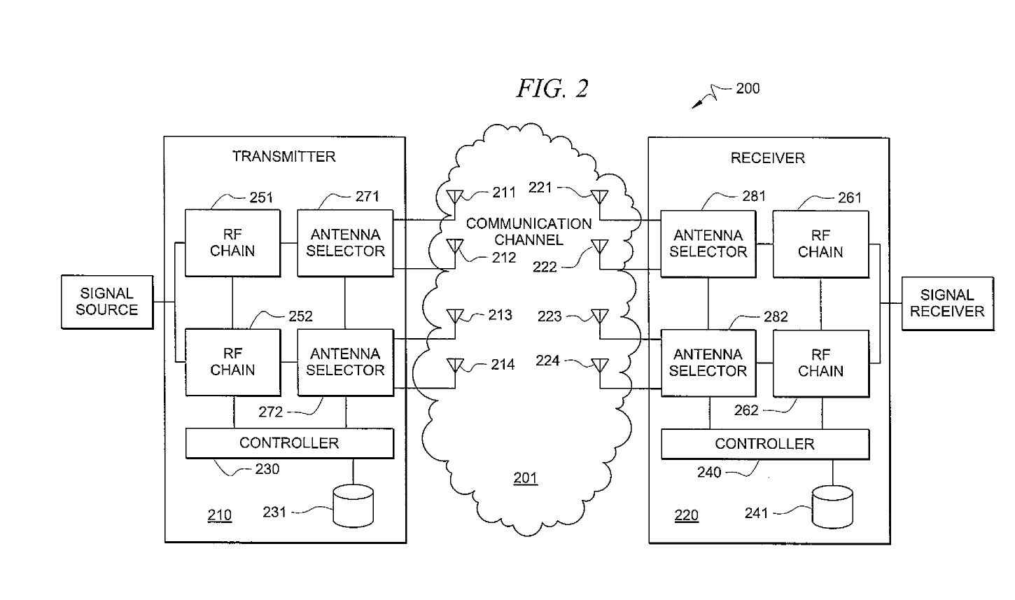

Directing attention to FIG. 3, detail with respect to an embodiment of a method providing antenna selection using out of date channel state information, as briefly set forth in the example above, is shown. The embodiment illustrated in FIG. 3 provides a current channel state estimate using outdated channel state information, weighted by its temporal relevance (e.g., a temporal correlation factor), and statistical information (e.g., a randomness factor derived from statistical spatial correlation of the channel), which also may be weighted by the temporal relevance of the outdated channel state information. Accordingly, channel state temporal correlations are estimated at box 301 and a statistical channel model is created at box 302 for use in estimating channel state information.

An estimate of channel state temporal correlation (box 301) may be made in a number of ways by embodiments of the invention. Preferably recent channel performance, such as may be provided by recent channel state information (H(t)), with historical performance information, such as may be derived using past channel state information, is used to derive a channel state temporal function (J₀), e.g., where J₀, is the zeroth order Bessel function of the first kind, used in estimating a current channel state.

The equation below is but one example of an equation which may be utilized according to embodiments of the present invention to provide channel state temporal correlation estimation.

ρ=J₀(2πf_{d}Δt) (1)

In equation (1) above, f_{d} is maximum Doppler frequency, Δt measures the time difference from a time (t₁) at which perfect/accurate CSI is obtained and a time (t₂, where t₂=t₁+Δt) at which packet transmissions occur/an antenna selection decision has to be make. J₀ is the zeroth order Bessel function of the first kind and ρ is a correlation factor between the channel state at time t₂ and time t₁.

Although channel state temporal correlation estimates may be useful in estimating channel state information at a particular time, such channel state temporal estimates are likely to decrease in accuracy as the difference Δt in time from a time at which the channel state information used in the estimates was obtained and the time at which the channel state is to be estimated increases. Accordingly, embodiments of the invention also utilize statistical channel information in estimating a channel state.

A statistical channel model may be created (box 302) in a number of ways by embodiments of the invention. Preferably spatial modeling, taking into account physical attributes of the antennas, topography and morphology within the communication channel, etcetera, is used to derive statistical channel models. Measurement based on received packets can be used to compute certain parameters in a pre-defined statistical channel model.

A channel state temporal correlation factor, e.g., ρ in equation (1) above, is preferably utilized in weighting outdated channel state information and statistical channel information for estimating channel state information at a particular time (t₂). Accordingly, in providing antenna selection according to the embodiment of FIG. 3, channel state information at time t₁ is obtained (H(t)) at box 303 for use in estimating channel state information at time t₂ (H(t+Δt)) at box 304. The channel state information obtained at box 303 may be the same channel state information utilized in estimating channel state temporal correlation discussed above.

At box 304, the channel state information (H(t)) is used to estimate the channel state at a desired time (t₂). Preferably, outdated channel state information (meaning some time, Δt, has transpired between the time, t₁, of acquisition of the channel state information, H(t), and the time, t₂, channel state information, H(t+Δt), is to be estimated) and statistical channel information are weighted using a channel state temporal correlation factor, e.g., p in equation (1) above.

The equation below is but one example of an equation which may be utilized according to embodiments of the present invention to provide channel state information estimation.

H(t+Δt)=ρH(t)+√1−ρ²Rᵣₓ^{1/2}ΞRₜₓ^{1/2} (2)

In equation (2) above, H(t+Δt) is the estimated channel state information at time t+Δt (t₂), H(t) is the channel state information at time t (t₁), Rᵣₓ is a matrix of the spatial correlation of the channel at the receiver, Rₜₓ is a matrix of the spatial correlation of the channel at the transmitter, and Ξ is a random matrix with independent and identically distributed complex Gaussian random variables (here it is assumed that the correlated channel model observes a Kronecker structure, i.e. a product of Rtx, a random Gaussian matrix XI and Rtx). Accordingly, Rᵣₓ^{1/2}ΞRₜₓ^{1/2} provides statistical channel information which takes the randomness of the communication channel into account.

According to a preferred embodiment, ρ (a correlation factor between the channel state at a time t₂ (t+Δt and a time at which channel state information H(t) was obtained) is 1 when Δt is 0 and approaches 0 as Δt approaches ∞. Accordingly, in equation (2) above, as Δt grows larger the weight given to the out of date channel state information (H(t)) is less in the estimated channel state information (H(t+Δt)) and the weight given to the statistical channel information (Rᵣₓ^{1/2}ΞRₜₓ^{1/2}) is greater in the estimated channel state information (H(t+Δt)). Accordingly, the foregoing channel state estimate is bounded by perfect channel state information (providing F-norm based selection), where the temporal relevance of the outdated channel state information is high (e.g., “1”), and by pure statistical channel knowledge (providing SCK based selection), where the temporal relevance of the outdated channel state information is low (e.g., “0”), wherein different degrees of outdatedness of the outdated channel state information are accommodated in the channel state information estimates between the foregoing boundary conditions. Channel state information estimates provided according to embodiments of the invention may thus provide the benefits of the technique providing the closest correlation to the current channel state at the corresponding boundary condition, while providing benefits of both techniques between the boundary conditions.

At box 305, the channel state information estimate for time t₂ is used to select an antenna configuration for use in communicating at time t₂. For example, a decision matrix mapping various channel state information parameters to particular antenna configuration selections may be used according to embodiments of the invention. Such as decision matrix may be derived through predictive modeling, empirical results provided through testing and/or monitoring of operations, etcetera. Selection of an antenna configuration may be based upon various metrics, such as an antenna configuration predicted or determined to provide a best bit error rate, a best data rate, a highest signal quality, a highest signal to noise ratio, the least interference, etcetera.

The equation below is but one example of an equation which may be utilized according to embodiments of the present invention in selecting antenna configurations for use with respect to estimated channel state information.

$${S}_{r} , {S}_{t} = \text{arg} min E [ exp ( - \frac{{E}_{S}}{4 {σ}^{2}} {‖ {S}_{r} H ( t + Δ t ) {S}_{t} E ‖}^{2} ) ] \qquad ( 3 )$$

In equation (3) above, Sᵣₓ comprises a set of receive antennas selected, Sₜₓ comprises a set of transmit antennas selected, E is an error matrix of the space time code used in the communication channel, Eₛ denotes the symbol energy, and σ² is the variance of the channel noise. Accordingly, the foregoing equation provides an example of a closed-form solution for selecting transmit and receive antennas in terms of ρ, signal to noise ratio (SNR) (SNR=Es/ρ²), E, Rᵣₓ, and Rₜₓ.

After having selected a desired or appropriate antenna configuration for use at time t₂, processing according to the illustrated embodiment proceeds to box 306 wherein antenna selection information consistent with the selected antenna configuration is provided to receiver and/or transmitter equipment for implementation of the antenna selection. Thereafter, the receiver and/or transmitter preferably implement the antenna configuration selection at the appropriate time for communication through the communication channel.

It should be appreciated that the operations of the method described above may be performed by systems of a receiver (e.g. receiver 220 of FIG. 2) and/or systems of a transmitter (e.g., transmitter 210 of FIG. 2). For example, operations of boxes 301-306 may be performed by controller 240 of receiver 220 (should be the transmitter 210 instead of the receiver according to embodiments of the invention. In such an embodiment, information regarding antenna configuration selection may be provided by controller 240 to antenna selectors 281 and 282 to implement antenna selection at receiver 220. Likewise, information regarding antenna configuration selection may be provided by controller 240 to controller 230 of transmitter 210 for subsequent provision to antenna selectors 271 and 272 to implement antenna selection at transmitter 210. Of course, one or more operations may be performed external to receiver 220 and transmitter 210, if desired. For example, an external antenna selection control system (not shown), perhaps providing antenna selection operations with respect to a plurality of transmitters and receivers in a network, may perform some or all of the operations set forth in boxes 301-306.

When implemented in software or firmware, elements of the present invention are essentially the code segments to perform the operations described herein. The program or code segments can be stored in a computer or processor readable medium. Examples of the computer readable medium include an electronic circuit, a semiconductor memory device, a ROM, a flash memory, an erasable ROM (EROM), a floppy diskette, a compact disk CD-ROM, an optical disk, a hard disk, etcetera. Accordingly, a controller operable under control of such software or firmware to implement aspects of the present invention, such as controllers 230 and/or 240, may comprise a central processing unit (CPU) coupled to random access memory (RAM) (e.g., SRAM, DRAM, SDRAM, etcetera) and/or read only memory (ROM) (e.g., PROM, EPROM, EEPROM, etcetera) holding user and system data and programs as is well known in the art. Various input/output (I/O) interfaces may be provided, such as to provide signals to/from the controller from/to other components, such as antenna selectors (e.g., to determine currently a selected antenna configuration, to control antenna selection, etcetera), RF chains (e.g., to transmit a training sequence for obtaining channel state information, to monitor communications for obtaining channel state information, etcetera), and the like.

As mentioned above, the channel state estimate of embodiments is bounded by perfect channel state information (providing F-norm based selection), where the temporal relevance of the outdated channel state information is high (e.g., ρ=1), and by pure statistical channel knowledge (providing SCK based selection), where the temporal relevance of the outdated channel state information is low (e.g., ρ=0). Different degrees of outdatedness of the outdated channel state information are accommodated in the channel state information estimates between the foregoing boundary conditions (e.g., 1>ρ>0). Accordingly, optimal antenna selection provided according to embodiments of the present invention approach that of F-norm based selection where the F-norm selection technique (measured channel state information) is more optimal and that of SCK based selection where the SCK based selection technique (pure spatial statistical information) is more optimal, and diverges from each such technique where neither technique is optimal, to thereby provide optimal antenna selection.

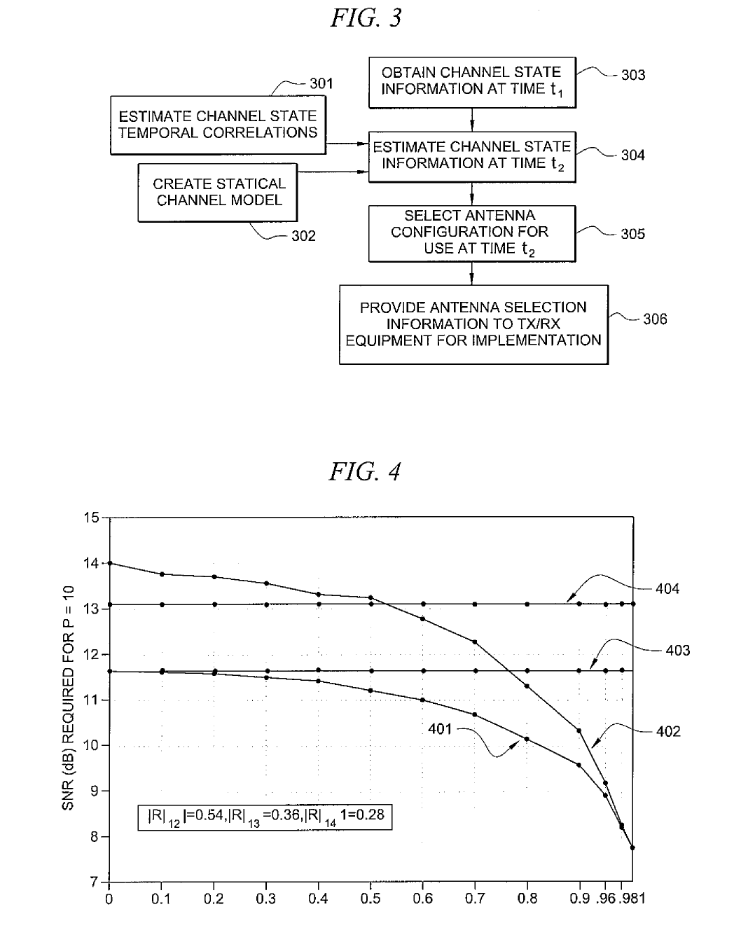

FIG. 4 illustrates the foregoing graphically. In the graph of FIG. 4, ρ is represented by the X axis and the signal to noise ratio (SNR) required to achieve a channel signal to error ratio (S ER) of 10⁻³ is represented by the Y axis. Curve 401 shows the optimal antenna selection provided in accordance with equations (1)-(3) above. Curve 402 shows antenna selection provided using F-norm selection (measured channel state information). Curve 403 shows antenna selection provided using SCK selection (spatial statistical information). As can be seen in the graph of FIG. 4, curve 401 approximates curve 402 where ρ is near 1 (channel state information is nearly perfect) and approximates curve 403 where ρ is near 0 (channel state information is outdated). However, at all places between the aforementioned boundary conditions, curve 401 is below curves 402 and 403, indicating improved communications due to optimal antenna selection in accordance with an embodiment of the invention. Line 404 of FIG. 4 represents purely random antenna selection and is provided as a reference with respect to the aforementioned curves.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for antenna configuration selection with respect to a wireless communication channel, said system comprising:
means for obtaining channel state information with respect to said communication channel;
means for determining a temporal correlation factor for said communication channel, said temporal correlation factor providing information correlating a state of said communication channel at a time at which said channel state information is obtained and a time subsequent to said time at which said channel state information is obtained;
means for estimating channel state information with respect to said communication channel at said time subsequent to a time at which said channel state information is obtained using said channel state information and said temporal correlation factor; and
means for selecting an antenna configuration from a plurality of antenna configurations using said estimated channel state information.

2. The system of claim 1, wherein said means for obtaining said channel state information uses information with respect to packets received through said communication channel.

3. The system of claim 1, wherein said means for determining said temporal correlation factor uses information with respect to packets previously received through said communication channel.

4. The system of claim 1, wherein said means for estimating said channel state information uses said temporal correlation factor to weight said channel state information.

5. The system of claim 1, further comprising:
means for obtaining statistical channel information with respect to said communication channel, wherein said statistical channel information is used with said channel state information and said temporal correlation factor by said means for estimating channel state information.

6. The system of claim 5, wherein said means for estimating said channel state information uses said correlation factor to weight said channel state information and said statistical channel information.

7. The system of claim 6, wherein weighting of said channel state information comprises a product of said temporal correlation factor and said channel state information and weighting of said statistical information comprises a product of a square root of one minus said temporal correlation factor squared and said statistical channel information.

8. The system of claim 5, wherein said statistical channel information comprises a receiver correlation matrix and a transmitter correlation matrix.

9. The system of claim 8, wherein said statistical channel information further comprises a random portion.

10. The system of claim 1, wherein said antenna configuration comprises selected antennas.

11. The system of claim 1, wherein said antenna configuration comprises selected antenna beams.

12. The system of claim 1, wherein said system is operable with respect to a multiple in, multiple out (MIMO) wireless communication system.

13. The system of claim 1, wherein said system is operable with respect to a bursty data system.

14. A method comprising:
obtaining channel state information for a communication channel at a first time;
estimating channel state information for said communication channel at a second time using said obtained channel state information; and
selecting a communication configuration for use at said second time using said estimated channel state information.

15. The method of claim 14, wherein said obtaining channel state information comprises:
determining channel state information from received packets.

16. The method of claim 15, wherein said received packets comprise training packets.

17. The method of claim 14, wherein said obtained channel state information is out dated at said second time.

18. The method of claim 14, wherein said estimating channel state information comprises:
determining a temporal channel correlation factor for use in said estimating.

19. The method of claim 18, wherein said estimating channel state information further comprises:
using said temporal channel correlation factor to weight said obtained channel state information.

20. The method of claim 18, wherein said estimating channel state information further comprises:
obtaining statistical channel information for said communication channel for use in said estimating.

21. The method of claim 20, wherein said obtaining statistical channel information comprises:
creating a statistical channel model.

22. The method of claim 21, wherein said statistical channel model comprises at least one spatial correlation matrix.

23. The method of claim 20, wherein said estimating channel state information further comprises:
using said temporal channel correlation factor to weight said obtained channel state information; and
using said temporal channel correlation factor to weight said statistical channel information.

24. The method of claim 14, wherein said communication configuration is selected to provide a best bit error rate with respect to said channel having a channel state consistent with said estimated channel state information.

25. The method of claim 14, wherein said communication configuration is selected to provide a best data rate with respect to said channel having a channel state consistent with said estimated channel state information.

26. The method of claim 14, wherein said communication configuration is selected to provide a highest signal quality with respect to said channel having a channel state consistent with said estimated channel state information.

27. The method of claim 14, wherein said communication configuration is selected to provide a highest signal to noise ratio with respect to said channel having a channel state consistent with said estimated channel state information.

28. The method of claim 14, wherein said communication configuration is selected to provide least interference rate with respect to said channel having a channel state consistent with said estimated channel state information.

29. The method of claim 14, wherein said communication configuration comprises a subset of antennas selected from a plurality of antennas.

30. The method of claim 14, wherein said communication configuration comprises a selected configuration of antenna beams.

31. A method for providing antenna selection with respect to a wireless communication channel, said method comprising:
estimating channel temporal correlations using information with respect to previously received data packets;
estimating channel state information using said estimated channel temporal correlations and at least a portion of said information with respect to said previously received data packets; and
making an antenna selection for use with said communication channel using said estimated channel state information.

32. The method of claim 31, further comprising:
determining a channel temporal correlation factor from said estimated channel temporal correlations, wherein said estimating channel state information using said estimated channel temporal correlations comprises weighting obtained channel state information using said channel temporal correlation factor.

33. The method of claim 31, further comprising:
determining statistical channel information using spatial correlations for a plurality of antennas used with respect to said communication channel, wherein said estimating channel state information further uses said statistical channel information.

34. The method of claim 33, further comprising:
determining a channel temporal correlation factor from said estimated channel temporal correlations, wherein said estimating channel state information using said estimated channel temporal correlations comprises weighting obtained channel state information using said channel temporal correlation factor and weighting said statistical channel information using said channel temporal correlation factor.

35. The method of claim 34, wherein said weighting results in said estimated channel state information approximating said obtained channel state information for a time approximating when said obtained channel state information was obtained and said estimated channel state information approximating said statistical channel information for a time subsequent to when said obtained channel state information was obtained.
